(19) United States
(12) Patent Application Publication
(10) Pub. No.: US 2005/0254744 A1
(43) Pub. Date: Nov. 17, 2005

(54) Sensing system

(76) Inventor: Neville John Freeman, Utkinton (GB)

Correspondence Address: FENWICK & WEST LLP, SILICON VALLEY CENTER, 801 CALIFORNIA STREET, MOUNTAIN VIEW, CA, 94041, US

(21) Appl. No.: 10/504,671

(22) PCT Filed: Jan. 23, 2003
(86) PCT No.: PCT/GB03/00309

§ 371 Date: Jun. 20, 2005

(30) Foreign Application Priority Data
Feb. 15, 2002 (GB) 0203581.4

(51) Int. Cl. G02B 6/00

(52) U.S. Cl. 385/12

(57) ABSTRACT

A sensing system comprises a spacer at the interface of a sensor component and a secondary structure.

The present invention relates to a sensing system comprising a spacer at the interface of a sensor component and a secondary structure and to the spacer per se.

WO-A-98/22807, WO-A-01/36945 and WO-A-99/63330 disclose a sensor component comprising at least two waveguides formed in a laminar fashion. In one waveguide, there is exhibited or induced a measurable response to a change in the localised environment caused by the introduction of or changes in a stimulus (eg a chemical, physical or biological stimulus). In order to expose the sensor component to the localised environment or to achieve some other desired effect (eg an optical effect), it may be necessary to use a secondary structure such as a structural, mechanical or optical function. For example, WO-A-01/36945 describes a microstructure positionable in contact with the sensor component for intimately exposing the sensor component to the localised environment. However, by placing secondary structures in direct contact with the surface of the sensor component, there may be a deleterious effect on the output. For example, the material of the secondary structure may absorb radiation or induce scatter from the surface of the sensor component resulting in a significant loss of power therefrom. This may effectively render the sensor component inoperable.

WO-A-99/63330 discloses a sophisticated secondary structure for housing a sensor component which addresses the aforementioned drawbacks by providing surface contact properties which allow the sensor component to operate satisfactorily. At the same time, the device substantially eliminates stray electromagnetic radiation passing over the surface of the sensor component which would otherwise contribute to the output. This is achieved mechanically in the secondary structure by a housing adapted to receive internally a holder for mounting the sensor component, together with a guiding means for correlating along a longitudinal path the position of the sensor component and a source of electromagnetic radiation so as to expose the sensor component effectively in free space. The material from which the component parts are made is generally absorbent to the excitation radiation. The guiding means may be incorporated in the sensor component or in the housing during manufacture. In either case, additional manufacturing steps are required which are both difficult and costly.

The present invention seeks to improve sensing systems by incorporating a spacer at the interface of a sensor component and a secondary structure to overcome the above disadvantages without recourse to sophisticated mechanical or material modifications of the sensor component or the secondary structure (eg the housing). In particular, the present invention relates to a spacer enabling a sensing system to be operated without catastrophic scattering into or absorption losses from the sensor component.

Thus viewed from one aspect the present invention provides a sensing system for detecting the presence or amount of or changes in a stimulus of interest in a localised environment, said sensing system comprising:

a sensor component including either (1) one or more sensing layers capable of inducing in a secondary waveguide a measurable response to a change in the localised environment caused by the introduction of or changes in the stimulus of interest or (2) a sensing waveguide capable of exhibiting a measurable response to a change in the localised environment caused by the introduction of or changes in the stimulus of interest;

a secondary structure adjacent to the sensor component; and

a spacer positioned at the interface of the sensor component and secondary structure so that a first face thereof is in contact with at least a part of either the secondary waveguide or the sensing waveguide.

The spacer represents an unsophisticated and inexpensive component permitting the difficulties associated with direct contact between the secondary structure and sensor component to be avoided.

In a preferred embodiment, the first face of the spacer is adapted to optically isolate the at least a part of the secondary waveguide or sensing waveguide with which it is in contact. Preferably the spacer is adapted optically and/or dimensionally to substantially eliminate stray electromagnetic radiation. For example, the thickness of the spacer may be greater than the penetration depth of the evanescent field of the secondary waveguide at the wavelength of the excitation radiation (ie to accommodate the majority of the evanescent field that is generated at that wavelength).

In an embodiment of the sensing system of the invention, a second face of the spacer opposite the first face is in contact with the secondary structure.

The spacer may be integral with the sensor component or with the secondary structure or may be discrete.

Where the spacer is integral with the secondary structure, it may be adapted optically and/or dimensionally to substantially eliminate stray electromagnetic radiation. Suitable optical properties are exhibited by polymers such as fluorinated ethylene propylene copolymer (FEP), polyethylene or PDMS and the spacer has a thickness which is tailored according to the structure of the sensor component and the wavelength of the excitation radiation. Typically the spacer has a thickness of 100 microns or less for an excitation wavelength of about 0.5 microns. Preferably the thickness is in the range 5 to 50 microns. Typically, the spacer is coated conventionally (eg spin coated) onto the relevant surface of the secondary structure.

Where the spacer is integral with the sensor component, it may be adapted optically and/or dimensionally to substantially eliminate stray electromagnetic radiation. Suitable optical properties are exhibited by silicon dioxide and the spacer has a thickness typically 10 microns or less, preferably 5 microns or less. The spacer may be conveniently applied to the sensor component by conventional methods such as chemical vapour deposition.

In a preferred embodiment, the spacer is discrete and optionally reusable. It is advantageous for the discrete spacer to be composed from an efficiently disposable material. Where the spacer is homogeneous, it may be adapted optically and/or dimensionally to substantially eliminate stray electromagnetic radiation. Suitable optical properties are exhibited by polymers such as fluorinated ethylene propylene copolymer (FEP), polyethylene or PDMS and the spacer has a thickness which is tailored according to the structure of the sensor component and the wavelength of the excitation radiation (with due consideration to the mechanical robustness of the structure). Typically the spacer has a thickness of 100 microns or less for an excitation wavelength of about 0.5 microns. Preferably the thickness is in the range 50 to 100 microns.

Preferably the discrete spacer adopts a layered structure comprising a core layer coated on its lower face with a contact layer and optionally on its upper face with a contact layer. The discrete spacer is positioned onto the sensor component so that the contact layer is in contact with the secondary waveguide or sensing waveguide without catastrophic scattering into or absorption losses therefrom. Preferably the or each contact layer is adapted dimensionally and optically to substantially eliminate stray electromagnetic radiation. The discrete spacer may form a compressible seal between the secondary structure and the sensor component.

The or each contact layer may be a thin film (eg a thin film having a thickness of 3 microns or more for an excitation wavelength of 0.5 microns). Preferably the thin film has a thickness in the range 3 to 100 microns. The or each contact layer may exhibit low optical loss. Typically, the or each contact layer is composed of polydimethylsiloxane (PDMS). The upper and/or lower coating may be coated conventionally (eg spin coated) onto the core layer.

The core layer may be composed of a material which is substantially non-transmissive (eg opaque) to the excitation radiation, preferably non-transmissive to the excitation radiation (eg to excitation radiation in the visible spectrum). Preferably the core layer is composed of VITON®.

Preferably the spacer incorporates a window which bounds the localised environment above the at least a part of the secondary waveguide or sensing waveguide with which the spacer is in contact. The window may adopt any convenient shape and is typically substantially square. The incorporation of a window advantageously ensures intimate contact between the stimulus of interest and the sensor component. For example, the window may bound a sensing layer such as an absorbent material or a bioactive material (described in greater detail below).

The spacer may incorporate a plurality of windows defining a plurality of localised environments in connection with which separate sensing measurements may be made. Alternatively the sensing system may comprise a plurality of spacers each positioned at the interface of the sensor component and secondary structure so that a first face thereof is in contact with at least a part of either the secondary waveguide or the sensing waveguide, said at least a part of either the secondary waveguide or sensing waveguide being exposed to a discrete localised environment.

The sensor component may be any of the type disclosed in WO-A-98/22807, WO-A-01/36945 and WO-A-99/63330.

The secondary structure may be any device or apparatus which might usefully be used in conjunction with and adjacent to the sensor component in the sensing system and specific examples are described hereinafter.

The secondary structure may be a support means for supporting a sensor component such as a holder or housing used to mount the sensor component.

The secondary structure may be a means for intimately exposing at least a part of the (or each) sensing layer or the sensing waveguide to the localised environment (eg of the type disclosed in WO-A-01/36945). For example the means for intimately exposing at least a part of the sensing layer or the sensing waveguide to the localised environment may be adapted to permit the continuous introduction into the localised environment of an analyte containing a chemical stimulus of interest (ie a dynamic system). For example, it may permit the continuous introduction of the stimulus of interest in a discontinuous flow (eg as a train of discrete portions) into the localised environment. This may be achieved by capillary action or by a separate urging means. Preferably the means for intimately exposing at least a part of the sensing layer or the sensing waveguide to the localised environment is adapted to induce chemical reactions or interactions in a static analyte containing a chemical stimulus of interest. In this sense, the sensing system may be considered to be dynamic. Chemical reactions or interactions may be induced in any conventional manner such as by heat or radiation. Preferably the means for intimately exposing at least a part of the sensing layer or the sensing waveguide to the localised environment in the form of one or more microchannels and/or microchambers. For example, an analyte containing chemical stimuli may be fed through microchannels or chemical reactions or interactions may take place in an analyte located in a microchamber. An analyte containing chemical stimuli may be fed into the microchannels by capillary action or positively fed by an urging means.

The secondary structure may be quadrature electric field tracks or other microfluidic sensing devices, an electromagnetic source (eg a laser) and/or means for detecting electromagnetic radiation (of the types detailed below) or a chemical separating means (eg an HPLC based device).

Preferably the sensing system of the invention is adapted so as to be usable in evanescent mode or whole waveguide mode.

Thus in a first embodiment of the sensing system, the sensor component includes one or more sensing layers capable of inducing in a secondary waveguide a measurable response to a change in the localised environment caused by the introduction of or changes in the stimulus of interest. In this first embodiment, the sensing system is advantageously adapted to optimise the evanescent component so as to induce in the secondary waveguide a measurable optical response. The sensor component may comprise a plurality of separate sensing layers to enable changes at different localised environments to be detected.

In a preferred sensing system of the invention, the sensing layer comprises an absorbent material (eg a polymeric material such as polymethylmethacrylate, polysiloxane, poly-4-vinylpyridine) or a bioactive material (eg containing antibodies, enzymes, DNA fragments, functional proteins or whole cells). The absorbent material may be capable of absorbing a gas, a liquid or a vapour analyte containing a chemical stimulus of interest. The bioactive material may be appropriate for liquid or gas phase biosensing. For example, the sensing layer may comprise a porous silicon material optionally biofunctionalised with antibodies, enzymes, DNA fragments, functional proteins or whole cells.

In a preferred sensing system of the invention, the secondary waveguide comprises silicon nitride or (preferably) silicon oxynitride.

In a second embodiment of the invention, the sensor component includes a sensing waveguide capable of exhibiting a measurable response to a change in the localised environment caused by the introduction of or changes in the stimulus of interest. In this second embodiment, the sensing system is adapted to minimise the evanescent component and may be used advantageously in a whole waveguide mode.

In a preferred sensing system of the invention, the sensing waveguide comprises an absorbent material (eg a polymeric material such as polymethylmethacrylate, polysiloxane, poly-4-vinylpyridine) or a bioactive material (eg containing antibodies, enzymes, DNA fragments, functional proteins or whole cells). The absorbent material may be capable of absorbing a gas, a liquid or a vapour analyte containing a chemical stimulus of interest. The bioactive material may be appropriate for liquid or gas phase biosensing. For example, the sensing waveguide may comprise a porous silicon material optionally biofunctionalised with antibodies, enzymes, DNA fragments, functional proteins or whole cells.

Where the sensor component of the sensing system of the invention comprises a sensing waveguide adapted for use in whole waveguide mode, an absorbent layer in the form of an overcoating may be present for use as a membrane (for example) to separate out stimuli of interest.

To optimise the performance of the first embodiment, the sensor component may further comprise an inactive secondary waveguide in which the sensing layer is incapable of inducing a measurable response to a change in the localised environment caused by the introduction of or changes in the stimulus of interest. The inactive secondary waveguide is capable of acting as a reference layer. It is preferred that the secondary waveguide and inactive secondary waveguide have identical properties with the exception of the response to the change in the localised environment caused by the introduction of or changes in the stimulus of interest. By way of example, the secondary waveguide and inactive secondary waveguide is made of silicon oxynitride.

To optimise the performance of the second embodiment, the sensor component may further comprise an inactive (eg deactivated) waveguide substantially incapable of exhibiting a measurable response to a change in the localised environment caused by the introduction of or changes in the stimulus of interest. The inactive waveguide is capable of acting as a reference layer. The physical, biological and chemical properties of the sensing waveguide and inactive waveguide are as similar as possible (with the exception of the response to the change in the localised environment caused by the introduction of or changes in the stimulus of interest). Typically the inactive waveguide is made of silicon oxynitride.

Preferably each of the sensing waveguide or secondary waveguide (or any additional waveguides such as reference waveguides) of the sensor component is a planar waveguide (ie a waveguide which permits light propagation in any arbitrary direction within the plane).

Preferably, the sensor component of the sensing system of the invention constitutes a multi-layered structure (eg a laminated waveguide structure). In this sense, the sensing system is simple to fabricate and fault tolerant in terms of construction errors. In a preferred embodiment, each of the plurality of layers in the multi-layered sensor component are built onto a substrate (eg of silicon) through known processes such as PECVD, LPCVD, etc. Such processes are highly repeatable and lead to accurate manufacture. Intermediate transparent layers may be added (eg silicon dioxide) if desired. Typically the sensor component is a multilayered structure of thickness in the range 0.2-10 microns. A layered structure advantageously permits layers to be in close proximity (eg a sensing waveguide and an inactive (reference) waveguide may be in close proximity to one another so as to minimise the deleterious effects of temperature and other environmental factors).

Preferably, the sensor component comprises a stack of transparent (to the excitation wavelength) dielectric layers wherein layers are placed in close proximity. Preferably each layer is fabricated to allow equal amounts of optical radiation to propagate by simultaneous excitation of the guided modes in the structure. Particularly preferably the amount of light in the sensing waveguide/inactive waveguide or in the secondary waveguide/inactive secondary waveguide is equal.

Preferably the sensing system comprises: means for measuring the response (to the change in the localised environment caused by the introduction of or changes in the stimulus of interest) of the sensor component.

The sensing system of the invention may advantageously be used to detect the amount of or changes in a chemical stimuli in an analyte which is introduced into the sensing system (ie a chemical sensing system). For example, a gaseous or liquid phase analyte comprising chemical stimuli may be introduced into the sensing system. Alternatively, a chemical reaction may take place which effects changes in the nature of the chemical stimuli in situ and causes a change in the localised environment.

The sensing system of the invention may be used to measure inter alia pressure, position, temperature or vibration in relation to the extent of or changes in a physical stimulus (ie a physical sensing system). The physical stimulus may be applied to the sensing layer or sensing waveguide of the sensor component via a secondary structure such as an impeller (for example) to enable the measurement of (for example) pressure or precise position. Direct contact is avoided in accordance with the invention by the use of the spacer.

Electromagnetic radiation generated from a conventional source may be propagated into the sensor component in a number of ways. In a preferred embodiment, radiation is simply input via an end face of the sensor component (this is sometimes described as “an end firing procedure”). Preferably (but not essentially), the electromagnetic radiation source provides incident electromagnetic radiation having a wavelength falling within the optical range. Propagating means may be employed for substantially simultaneously propagating incident electromagnetic radiation into a plurality of waveguides. For example, one or more coupling gratings or mirrors may be used. A tapered end coupler rather than a coupling grating or mirror may be used to propagate light into the lowermost waveguide.

The incident electromagnetic radiation may be oriented (eg plane polarised) as desired using an appropriate polarising means. The incident electromagnetic radiation may be focussed if desired using a lens or similar micro-focussing means.

Using electromagnetic radiation of different frequencies (either simultaneously or sequentially) varies the contributions of the various waveguides and may further enhance the utility of the sensing system Multimode excitation may provide useful additional information. By comparing the outer and inner areas of the interference pattern, it may be possible to determine the extent to which any refractive index change has been induced by changes in the thickness of the outer regions (ie the dimensional changes) and the degree to which it has been effected by physico-chemical changes in the inner regions (ie compositional changes).

By way of example, both the TE (transverse electric) and the TM (transverse magnetic) excitation modes may be used sequentially or simultaneously to interrogate the sensing system as described for example in WO-A-01/36946. In this sense, the sensing system comprises: first irradiating means for irradiating the sensor component with TM mode electromagnetic radiation and second irradiating means for irradiating the sensor component with TE mode electromagnetic radiation. The relative phase changes of the two modes are used to identify and quantify the nature of the optical changes taking place in the sensing layer or sensing waveguide. For example, it may be possible to attribute changes in the effective refractive index of the sensing layer or sensing waveguide to specific changes in dimension (eg expansion or contraction) and/or composition. The relative phase changes of the two modes may also be used to identify such changes taking place in subsequent layers when more compact structures are employed. Conveniently, measurement of capacitance and refractive mode index of the two modes yields further information on changes occurring in the absorbent layer.

Electromagnetic radiation may be modulated (amplitude, frequency or phase for example) to provide additional information on the behaviour of the sensing system.

As a consequence of the introduction of or changes in a physical, biological and/or chemical stimulus in the localised environment (ie a change in the refractive index of material in the localised environment), changes in the dielectric properties (eg the effective refractive index) of the sensing waveguide or sensing layer occur. This causes a measurable optical response (ie a change in the transmission of electromagnetic radiation down the sensing waveguide (or waveguides) in whole waveguide mode or the secondary waveguide in evanescent field mode).

An interference pattern may be generated when the electromagnetic radiation from the sensor component is coupled into free space and the pattern may be recorded in a conventional manner (see for example WO-A-98/22807). In this embodiment, a measurable optical response of the sensor component to a change in the localised environment manifests itself as movement of the fringes in the interference pattern. The phase shift of the radiation in the sensor component (eg induced in the secondary waveguide in evanescent field mode or exhibited in the sensing waveguide in whole waveguide mode) may be calculated from the movement in the fringes. In turn, the amount of or changes in a chemical, biological or physical stimulus in the localised environment may be calculated from the phase shift.

The sensor component may be excited across its width and a two-dimensional photodiode array (or the like) may be used to effectively interrogate “strips” of the sensor component (eg an array sensor). This may be carried out across more than one axis simultaneously or sequentially to provide spatially resolved information relating to events on the surface of the sensor component.

The sensor component may be perturbed (eg thermally perturbed) to enable the sensing system to be biassed such as is described in WO-A-01/36947.

Movement in the interference fringes may be measured either using a single detector which measures changes in the electromagnetic radiation intensity or a plurality of such detectors which monitor the change occurring in a number of fringes or the entire interference pattern. The one or more detectors may comprise one or more photodetectors. Where more than one photodetector is used this may be arranged in an array.

In an embodiment of the sensing system, the electromagnetic radiation source and one or more detectors are integrated with the sensor component into a single assembly.

A plurality of electromagnetic radiation detector units (eg in an array) and/or a plurality of electromagnetic radiation sources may be used to measure in discrete areas of the sensor component simultaneously the responses to changes in the localised environment. Alternatively, the position of the electromagnetic radiation detector and electromagnetic radiation source relative to the sensor component may be changed to provide information concerning responses in discrete areas of the sensor component. For example, discrete responses to a change in the localised environment caused by the amount of the same or different stimuli may be measured in discrete areas of the sensor component. In the first instance, concentration gradients of the same stimulus may be deduced. In the second instance, discrete responses to changes in the localised environment may be measured in different regions. For this purpose, the preferred device makes use of the versatility of the evanescent mode and comprises a plurality of separate sensing layers or regions.

Conveniently, secondary structures being electrodes positioned adjacent a surface of the sensing layer or sensing waveguide enable capacitance to be measured simultaneously. The electrodes may take the form of either parallel plates laid adjacently alongside the sensor component or as an interdigitated or meander system laid down adjacent to the top and bottom surfaces of the sensor component.

The sensing system of the invention may be used to detect the introduction of or changes in a chemical, physical or biological stimulus. The interaction of the stimulus with the sensing waveguide or sensing layer may be a binding interaction or absorbance or any other interaction.

Viewed from a further aspect the present invention provides a spacer as hereinbefore defined.

The present invention will now be described in a non-limitative sense with reference to the accompanying Figures in which:

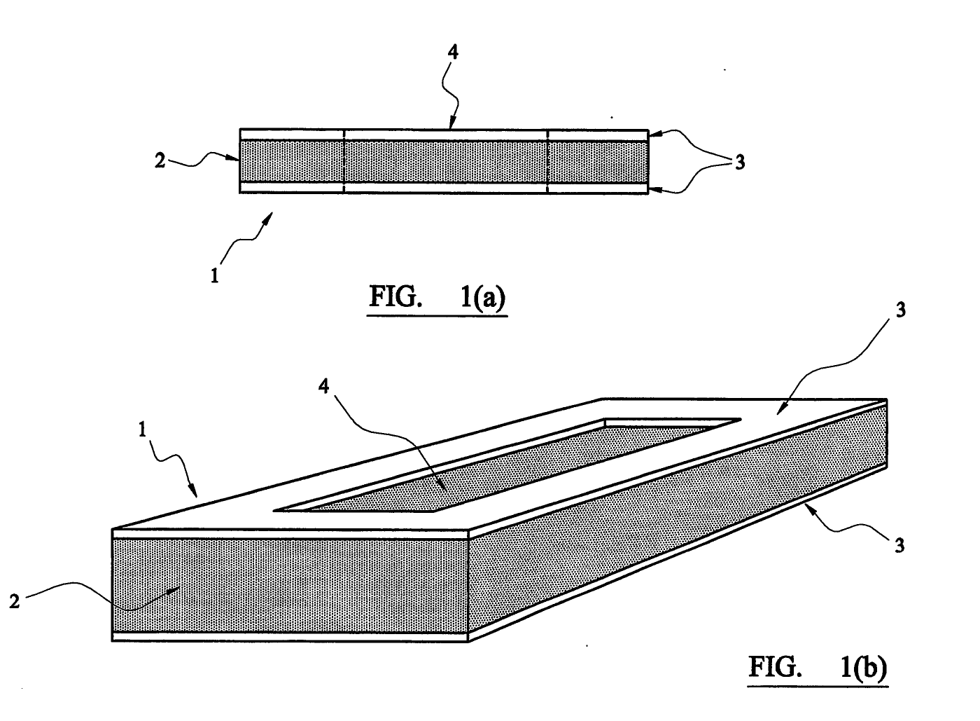

FIG. 1 illustrates an embodiment of the discrete spacer of the invention in (a) side elevation and (b) isometric projection;

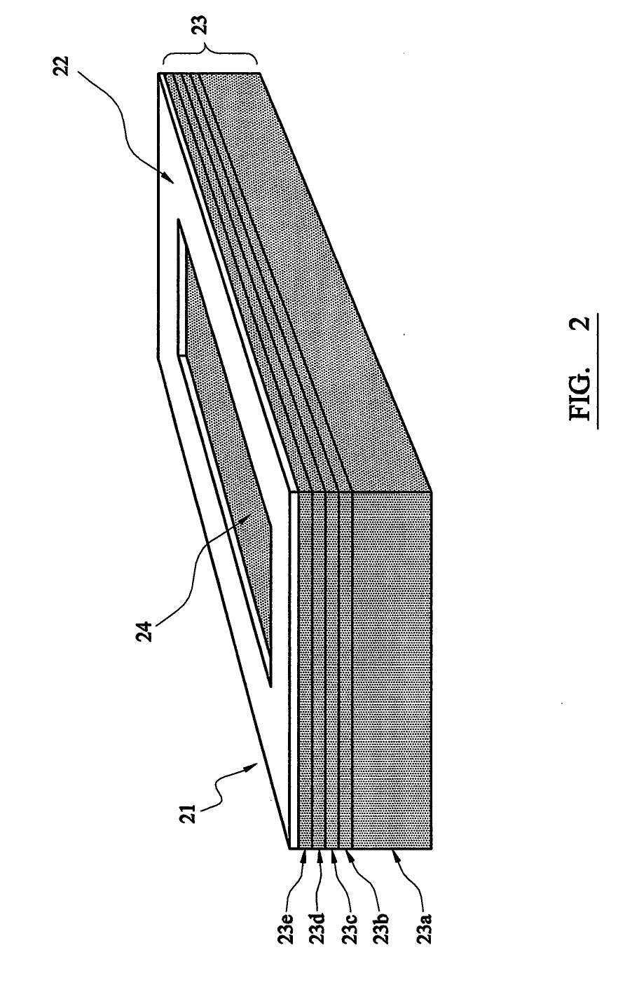

FIG. 2 illustrates a part of an embodiment of the sensing system of the invention; and

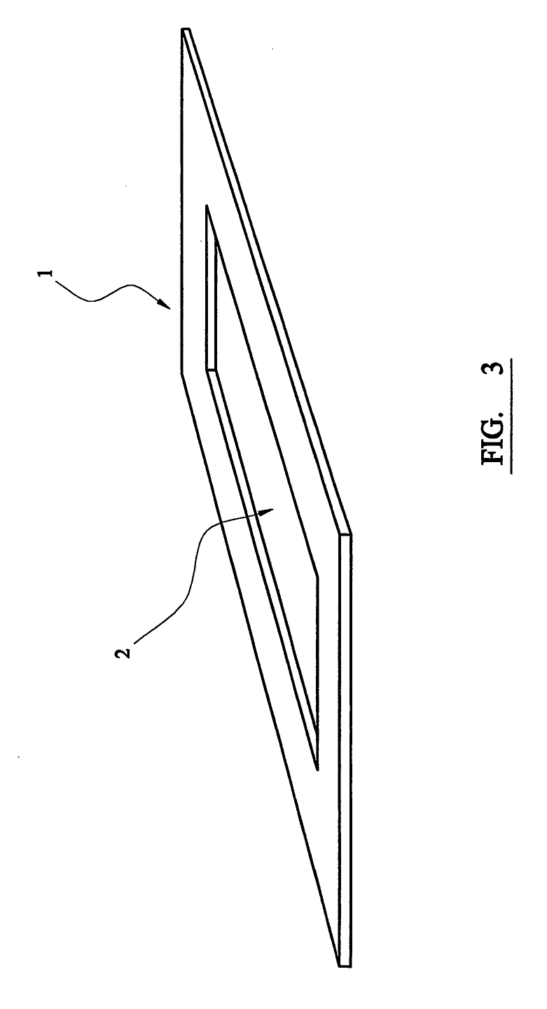

FIG. 3 illustrates a part of an embodiment of the sensing system of the invention.

FIG. 1 illustrates an embodiment of the spacer of the invention designated generally by reference numeral 1 in (a) side and (b) isometric projection views. The spacer is a discrete, layered structure comprising a core layer 2 of a material opaque to excitation radiation (eg Viton®). The upper and lower face of the core layer 2 is provided with a thin film coating 3 of a material with appropriate optical properties to contact the sensor component. It will be appreciated that (if desired) only one face may be provided with a thin film coating 3 to be brought into contact with the sensor component.

An appropriate material for the thin film coating is PDMS. A 5 micron thin film of PDMS is coated on the core material as follows:
(a) a solution of 4 ml of PDMS and 8 ml of hexane is made up and degassed;
(b) a solution of 0.4 ml of catalyst (for PDMS polymerisation) and 4 ml of hexane is made up and added to the PDMS solution; and
(c) the core material is dip coated in the solution prepared in (b) at a rate of 5 mm/sec.

The layered structure of the spacer 1 is provided with a substantially centrally disposed window 4 permitting access to the sensor component for stimuli such as test materials. The thin film 3 has the correct optical properties to contact the sensor component and the correct dimension to substantially eliminate stray irradiation from passing over the top of the sensor component.

FIG. 2 illustrates a part of an embodiment of the sensing system of the invention designated generally by reference numeral 21. The sensing system 21 comprises a sensor component 23 being a laminate structure comprising a silicon substrate layer 23a, a silicon dioxide cladding layer 23b (3 microns), a silicon dioxide spacing layer 23d (3 microns) and silicon oxynitride layers 23c (1 micron) and 23e (1 micron). A spacer 22 composed of silicon dioxide (3 microns) is integrally formed on the sensor component 23 so as to optically isolate an area of the silicon oxynitride layer 23e with which the spacer 22 is in contact. The spacer 22 incorporates an aperture 24 which bounds a localised environment above the area of the silicon oxynitride layer 23e with which the spacer 22 is in contact. In the evanescent mode, the silicon oxynitride layer 23e acts as the secondary (sensing) waveguide and the silicon oxynitride layer 23c acts as a reference waveguide when a sensing layer of (or incorporating) a stimulus is introduced into the localised environment.

FIG. 3 illustrates an embodiment of the spacer of the invention isolated from the secondary structure of which it is an integral part and designated generally by reference numeral 1. The spacer 1 is composed of a layer of material with suitable optical properties such as FEP, polyethylene or PDMS and has a thickness typically 100 microns or less to ensure that stray electromagnetic radiation is substantially eliminated. The spacer incorporates a window 2 which defines the localised environment to which the sensor component is exposed when the spacer 1 is in contact with the sensor component.

FIG. 3 could equally describe a homogeneous discrete spacer composed of material with suitable optical properties such as FEP, polyethylene or PDMS which has a thickness typically 100 microns or less to ensure that stray electromagnetic radiation is substantially eliminated and greater than 50 microns to be mechanically rigid (ie to avoid scrunching).

1. A sensing system for detecting the presence or amount of or changes in a stimulus of interest in a localised environment, said sensing system comprising:
a sensor component including either (1) one or more sensing layers capable of inducing in a secondary waveguide a measurable response to a change in the localised environment caused by the introduction of or changes in the stimulus of interest or (2) a sensing waveguide capable of exhibiting a measurable response to a change in the localised environment caused by the introduction of or changes in the stimulus of interest;
a secondary structure adjacent to the sensor component; and
a spacer positioned at the interface of the sensor component and secondary structure so that a first face thereof is in contact with at least a part of either the secondary waveguide or the sensing waveguide.

2. A sensing system as claimed in claim 1 wherein the first face of the spacer is adapted to optically isolate the at least a part of the secondary waveguide or sensing waveguide with which it is in contact.

3. A sensing system as claimed in claim 1 wherein the spacer is adapted optically and/or dimensionally to substantially eliminate stray electromagnetic radiation.

4. A sensing system as claimed in claim 1 wherein the thickness of the spacer is greater than the penetration depth of the evanescent field of the secondary waveguide at the wavelength of the excitation radiation.

5. A sensing system as claimed in claim 1 wherein a second face of the spacer opposite the first face is in contact with the secondary structure.

6. A sensing system as claimed in claim 1 wherein the spacer is integral with the sensor component or with the secondary structure.

7. A sensing system as claimed in claim 6 wherein the spacer is integral with the secondary structure and is composed of fluorinated ethylene propylene copolymer (FEP), polyethylene or polydimethylsiloxane (PDMS).

8. A sensing system as claimed in claim 6 wherein the spacer is integral with the secondary structure and has a thickness of 100 microns or less for an excitation wavelength of about 0.5 microns.

9. A sensing system as claimed in claim 8 wherein the spacer has a thickness in the range 5 to 50 microns.

10. A sensing system as claimed in claim 7 wherein the spacer is spin coated onto the surface of the secondary structure.

11. A sensing system as claimed in claim 6 wherein the spacer is integral with the sensor component and is composed of silicon dioxide.

12. A sensing system as claimed in claim 6 wherein the spacer is integral with the sensor component and has a thickness of 10 microns or less, preferably 5 microns or less.

13. A sensing system as claimed in claim 1 wherein the spacer is discrete.

14. A sensing system as claimed in claim 13 wherein the spacer is composed of an efficiently disposable material.

15. A sensing system as claimed in claim 13 wherein the spacer is composed of fluorinated ethylene propylene copolymer (FEP), polyethylene or polydimethylsiloxane (PDMS).

16. A sensing system as claimed in claim 13 wherein the spacer has a thickness of 100 microns or less for an excitation wavelength of about 0.5 microns.

17. A sensing system as claimed in claim 16 wherein the thickness of the spacer is in the range 50 to 100 microns.

18. A sensing system as claimed in claim 13 wherein the discrete spacer adopts a layered structure comprising a core layer coated on its lower face with a contact layer and optionally on its upper face with a contact layer whereby in use the discrete spacer is positioned onto the sensor component so that the contact layer is in contact with the secondary waveguide or sensing waveguide.

19. A sensing system as claimed in claim 18 wherein the or each contact layer is adapted dimensionally and optically to substantially eliminate stray electromagnetic radiation.

20. A sensing system as claimed in claim 18 wherein the discrete spacer forms a compressible seal between the secondary structure and the sensor component.

21. A sensing system as claimed in claim 18 wherein the or each contact layer is a thin film.

22. A sensing system as claimed in claim 21 wherein the thin film has a thickness in the range 3 to 100 microns.

23. A sensing system as claimed in claim 18 wherein the or each contact layer is composed of polydimethylsiloxane (PDMS).

24. A sensing system as claimed in claim 18 wherein the core layer is composed of a material which is substantially non-transmissive to the excitation radiation.

25. A sensing system as claimed in claim 24 wherein the core layer is composed of VITON7.

26. A sensing system as claimed in claim 1 wherein the spacer incorporates a window which bounds the localised environment above the at least a part of the secondary waveguide or sensing waveguide with which the spacer is in contact.

27. A sensing system as claimed in claim 26 wherein the window bounds an absorbent material or a bioactive material.

28. A sensing system as claimed in claim 1 wherein the sensor component includes one or more sensing layers capable of inducing in a secondary waveguide a measurable response to a change in the localised environment caused by the introduction of or changes in the stimulus of interest.

29. A sensing system as claimed in claim 1 wherein the sensor component includes a sensing waveguide capable of exhibiting a measurable response to a change in the localised environment caused by the introduction of or changes in the stimulus of interest.

30. (canceled)
